(19) United States
(12) Patent Application Publication
(10) Pub. No.: US 2002/0077122 A1
(43) Pub. Date: Jun. 20, 2002

(54) Method of providing travel information to a mobile communications device

(75) Inventor: Andrew T. Yule, Felbridge (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/015,852

(22) Filed: Nov. 30, 2001

(30) Foreign Application Priority Data
Dec. 14, 2000 (GB) 0030450.1

(51) Int. Cl. H04Q 7/20

(52) U.S. Cl. 455/456; 455/457; 455/451

(57) ABSTRACT

A method of providing travel related information to a user of a mobile communications device (MS1) is disclosed together with a corresponding mobile communications device (MS1) and a travel information beacon (11) for the same. The method comprising the steps of determining whether the mobile communications device (MS1) is either travelling on a transport (10), has recently traveled on a transport (10), or is likely to travel on a transport (10) at some time in the near future; and depending on the outcome of that determination, displaying to a user on the mobile communications device (MS1) selected travel related information.

### FIELD

This invention relates to a method of providing travel related information to a mobile communications device, especially a mobile cellular telephone.

### BACKGROUND OF THE INVENTION

WO-A-99/63358 discloses a method and device relating to a network position system which, in one implementation, can allow for the use of a mobile terminal to send position and time related data in addition to command functions such as a request for a taxi. A transport service provider such as a taxi company can then send data in reply to the mobile terminal confirming the booking and providing an anticipated waiting time before arrival of the requested taxi.

It is of course desirable to avoid or at least minimize the waiting time before arrival of the requested taxi and WO-A-00/41413 discloses an alternative arrangement with the aim of achieving this in which a mobile telephone is pre-programmed with a message specifying a place and time for pickup, and wherein the message is automatically sent to a transport service provider when the mobile telephone arrives at a specified location remote from the place for pickup. This arrangement has particular application where a regular passenger on a scheduled transport and in possession of such a telephone wishes to be met by a taxi upon his/her arrival at a scheduled transport terminus, the message being sent as the user approached that terminus.

In so far as WO-A-00/41413 is used by a user on scheduled transport, a disadvantage of this arrangement is that where the user programs the absolute time-of-arrival (TOA) in accordance with published timetable information, in the case of real-time delays in the scheduled transport, the proposed time for pick-up will be rendered inaccurate, i.e. the user may miss the proposed rendezvous with the taxi.

A further disadvantage of the arrangement in WO-A-00/41413 is the substantial burden placed on the user to pre-program the message including the place and time for pickup, especially considering the typically rudimentary user interfaces present on mobile telephones and other mobile communications devices. Similarly, where a user wishes to access information about a specified place, for example using an internet enabled mobile telephone to access a list of hotels located in a specific area, the burden of data entry using the typically rudimentary user interface is again experienced

### OBJECT OF THE INVENTION

It is an object of the invention to provide an improved method and associated apparatus for providing travel related information to a user of a mobile communications device, especially a mobile cellular telephone.

### SUMMARY OF THE INVENTION

According to the present invention, there is provided a method of providing travel related information to a user of a mobile communications device comprising the steps of determining whether the mobile communications device is either travelling on a transport, has recently traveled on a transport, or is likely to travel on a transport at some time in the near future; and depending on the outcome of that determination, displaying to a user of the mobile communications device selected travel related information.

The present invention is directed a mobile communications device which is intended to mean a device such as a mobile telephone, PDA or laptop which may be carried on and off a transport by a user and operable in a mode of operation that one would normally associate with such a device in both a travel and non-travel related context. By way of example, the same could not be said of a dedicated vehicle navigation system which is neither mobile in relation to a vehicle in which it is operative, nor is it capable of operatihg in a non-travel related context.

In relation to the mobile communications device of the present invention, travel related information might include information associated with travelling per se, perhaps in the form of advertising targeted to a traveler or information obtained from a website, which may be connected to automatically upon the aforementioned determination. It may also include a menu of travel related options.

The travel related information may also include be associated with a user's journey or the transport taken by the user. An example of the latter is where the travel information includes the identity of at least one location on the route of the transport. Where the travel related information includes the identities of more than location on the route of the transport, in order to minimize the burden of data entry by the user, it is desirable if the user is able to select as an option one of the locations displayed. I.e. based on the travel context, a user is provided with information which he/she would otherwise have to enter.

Where the transport is a scheduled transport, the travel related information may include the identity of at least one scheduled stop on the route and ideally only include those stops at which the user may subsequently alight.

Again where the mobile communications device is determined to be travelling on the scheduled transport, the travel related information may further include estimated TOA information. In such a case, in order to calculate an estimate of the TOA of the scheduled transport for at least one subsequent stop on route, it is necessary to providing an estimate of the current position of the mobile communications device and schedule information relating to the route of that transport. Where the travel related information includes the identities and TOAs for more than one stop on the route of the scheduled transport, it is desirable for the user to be able to select as an option one of the stops displayed.

The travel related information may be displayed for the purpose of enabling the user of the mobile communications device to access over a wireless link supplementary travel related information from an information service provider. For example, for the user to obtain a list of hotels located near to a station, that station having been selected by the user from a list of such stations on a given train route presented to the user.

The travel related information may be also displayed for the purpose of enabling to user of the mobile communications device to procure over a wireless link a travel related service for or on behalf of the user from a service provider. For example, a user may request a taxi with a pickup near to a station selected by the user from a list of such stations on a given train route presented to the user.

In either case, the travel related information may comprise a link to a website or mailbox of the information or service provider, and the supplementary travel related information or travel related service provided may be specifically related to a location on the route of the transport. Again in either case, the travel related information displayed may be merely an advertisement to access such supplementary travel related information or procure such a travel related service.

At least part of the determination of whether the mobile communications device is either travelling on a transport, has recently traveled on a transport, or is likely to travel on a transport at some time in the near future may be done by any or a combination for the following:

First, identifying whether the mobile communications device is currently or has recently received a message broadcasted from a transmitter located either on the scheduled transport, on or near the scheduled transport route or at or near a stop on the scheduled transport route.

Secondly, identifying whether the mobile communications device is located on the route of a scheduled transport or at or near a scheduled transport terminus. This would include where the mobile communications is currently or has recently received a message broadcasted from a transmitter located either on the scheduled transport, on or near the scheduled transport route or at or near a stop on the scheduled transport route, the message containing an estimate of the position of the transmitter, and wherein that position is used as an estimate of the position of the mobile communications device. Alternatively, it would also include where the mobile communications device comprises position determining means, for example, a GPS receiver or a communications receiver and communications processor adapted to determine the position of the mobile communications devices in co-operation with a plurality of cellular communication base stations.

It should be noted that this determination is not intended to include the scenario where general travel related information is provided to the user by an information beacon perhaps located near or in a transport terminus and the information automatically displayed to the user. An essential element of the determination is that the mobile communication is aware of its travel related context and behaves accordingly, and does not merely convey information to the user in a dumb fashion.

Thirdly, identifying whether the mobile communications device has been instructed by the user that either the user is travelling on a scheduled transport, has recently traveled on a scheduled transport or intends to travel on a scheduled transport at some time in the near future.

Fourthly, identifying whether the mobile communications device is currently in possession of an electronic ticket permitting travel on a scheduled transport. In such a case, the travel related information may be specifically related to a route identified by the electronic ticket or a stop on that route.

Further provided in accordance with the present invention is a mobile communications device as claimed in claims 29 to 51; and a travel information beacon as claimed in claims 52 to 61.

### BRIEF DESCRIPTION OF THE DRAWINGS

The present invention will now be described, by way of example only, with reference to the accompanying schematic drawings in which:

FIG. 1 shows a mobile cellular telephone in accordance with the present invention, located on a train and communicating with both a travel information beacon located on the train and a nearby cellular telephone network base station;

FIG. 2 shows the mobile cellular telephone of FIG. 1 in greater detail;

FIG. 3 shows the travel information beacon of FIG. 1 in greater detail;

FIG. 4 illustrates the route traveled by the train;

FIG. 5 represents travel related information broadcast by the travel information beacon of FIG. 1;

FIG. 6 shows the cellular telephone of FIG. 1 accessing remote internet based services;

FIG. 7 shows the apparatus employed by the remote internet based service provider of FIG. 6;

FIG. 8 and 9 represents information transmitted by the mobile cellular telephone MS1 to effect remote internet based services;

FIG. 10 shows a display of the cellular telephone of FIG. 1 for accessing remote internet based services as illustrated in FIG. 6;

FIG. 11 shows a further mobile cellular telephone in accordance with the present invention, located on a train, receiving GPS signals and communicating with a nearby cellular telephone network base station;

FIG. 12 shows the mobile cellular telephone of FIG. 8 in greater detail;

FIG. 13 represents travel related received by the mobile cellular telephone of FIG. 11 from a cellular telephone network; and

FIG. 14 illustrates an alternative deployment of travel information beacons in a train station.

### DESCRIPTION OF THE PREFERRED EMBODIMENTS

It should be noted that the same reference signs are generally used to refer to corresponding or similar features in different embodiments.

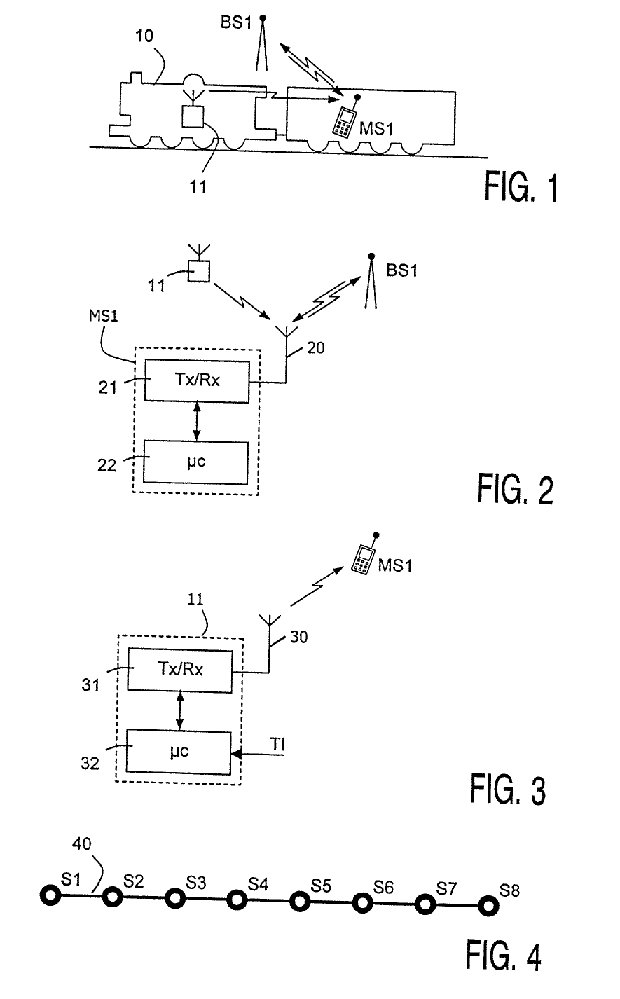

FIG. 1 shows a mobile cellular telephone MS1 in accordance with the present invention, located on a train 10 and in the possession of a passenger (not shown). The telephone is registered with nearby cellular telephone network base station BS1 facilitating voice and data communication with that base station and corresponding cellular telephone network. Data communication is intended to include sending text messages (for example using the short message service (SMS) protocol) and accessing the internet (for example using WAP or i-mode protocols). Additionally, the telephone is receiving wireless broadcasts from a travel information beacon 11 located on the train using a short range wireless communications protocol such as Bluetooth™ (a trademark of Telefonaktiebolaget LM Ericsson, Sweden).

Referring to FIG. 2, mobile cellular telephone MS1 is shown in greater detail comprising a communications transmitter (Tx) and receiver (Rx) 21 connected to a communications antenna 20 and controlled by a communications microprocessor (μc) 22 for communication with the base station BS1 with which it is registered. The same communications antenna and receiver 21 are also adapted to receive the broadcasts of the travel information beacon 11. In an alternative arrangement, an additional antenna and receiver combination can be provided such that broadcasts from both the cellular telephone network base station and the travel information beacon are received and processed independently. As the design and manufacture of such telephones for two-way communication within a cellular telephone network and with additional, independent wireless communication capability are well known, those parts which do not directly relate to the present invention will not be elaborated upon here further.

FIG. 3 shows the travel information beacon of FIG. 1 in greater detail also comprising a communications transmitter (Tx) and receiver (Rx) 31 connected to a communications antenna 30 and controlled by a communications microprocessor (μc) 32. Travel related information (TI) is supplied to the microprocessor and duly broadcasted to nearby receivers on board the train of which MS1 is one.

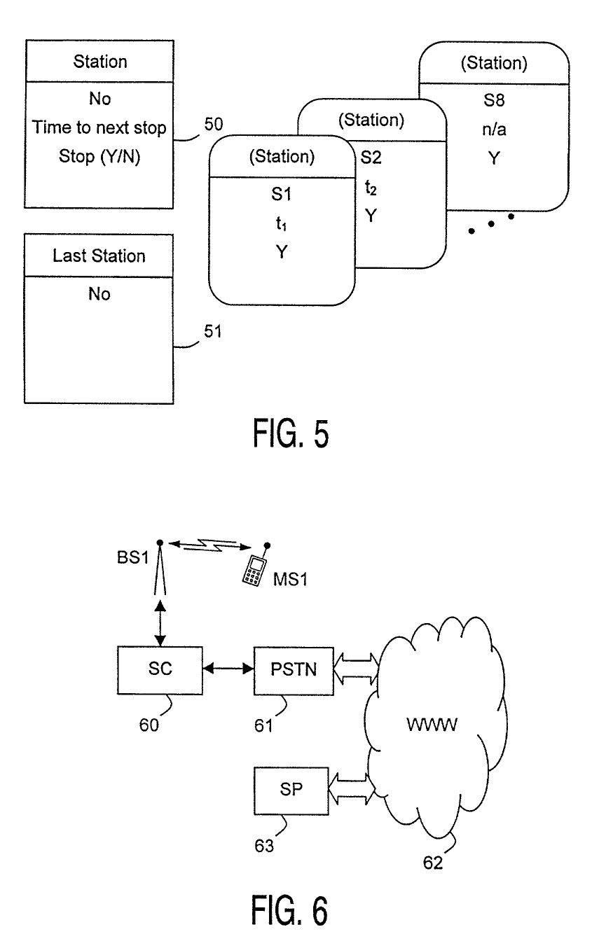

FIG. 4 illustrates the route 40 traveled by the train in which mobile telephone MS1 is located. The route consists of 8 stations and the train travels through the stations from station S1 to station S8, stopping at stations S1, S2, S3, S4, S6 before terminating at S8. That is, the train passes through but does not stop at stations S5 and S7. The travel information beacon broadcasts schedule information 50 relating to the route 40 of the train as illustrated in FIG. 5. The schedule information 50 comprises the expected time taken for the train to travel from station n to the next station along the line tₙ and an indication of whether or not the train with stop at that particular station. For example, t₂ is the expected time taken for the train to travel from station 2 to station 3 and S2 is flagged Y indicating that the train does stop there, the converse being flagged N. As the train terminates at station S8, there is no value for t₈, the expected time taken for the train to travel from station S8 to the next station. The travel information beacon also broadcasts the identity of the last stop that the train either went through or departed 51.

Referring back to FIG. 3, the travel related information TI supplied to the travel information beacon 11 must either include the schedule information or include information from which the schedule information can be determined. This may be provided to the communication microprocessor 32 beacon wirelessly, using removable computer storage media or in any other conventional manner of data transfer.

For the purposes of illustration, suppose that having just left station S1, the passenger in possession of mobile telephone MS1 wants to effect two mobile internet based services: first, the passenger wishes to request that a taxi is arranged to meet him/her upon arrival at their intended stop being station S6; and secondly, the passenger wishes to access information about hotels located in the area of their intended stop. The passenger first accesses the internet (www) 62 using their mobile cellular telephone in a conventional manner, as illustrated in FIG. 6, by transmitting and receiver data from the telephone MS1 via the base station BS1, a cellular network system controller (SC) 60, a public switched telephone network 61. The internet based service provider (SP) employs communication apparatus 63 connected to the web to communicate with the passengers telephone. For the purposes of this illustration, the internet service provider provides both a taxi ordering service and provide hotel information though in practice, it is more likely that these services with be provided by different service providers.

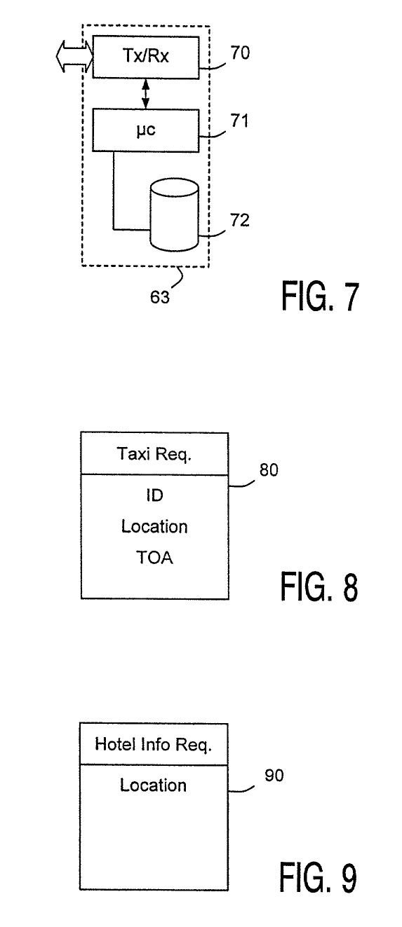

FIG. 7 shows the apparatus 62 employed by the remote internet based service provider in greater detail. As illustrated, the apparatus is arranged to receive, and deliver, signals to the internet 62 and includes a receiver 70 for receiving the travel-related request from the mobile telephone MS1. The apparatus further includes a data base 72 of travel-related information including, for example, information about hotels located in the area of each station (S1 to S8) on the train route 40. A processor 71 connected to the receiver 70 serves to calculate a response to the travel-related request in the manner described below:

The passenger wishes to request that a taxi is arranged to meet him/her upon arrival at their intended stop, station S6. Once an indication of a desire to book a taxi has been made, for example by accessing a particular web site address, the internet based service provider requires, as illustrated in FIG. 8, the following information 80: an identifier (ID) which to identify the passenger, the location of the pick-up, i.e. the intended stop of the passenger, and the estimated TOA. The mechanism with which the taxi is ordered and the service provider reimbursed for providing that service is beyond the scope of this invention, but an example is further described in PCT patent application PCT/EP99/08054, publication number WO 00/41413. The internet based service provider may then send a message confirm booking of the taxi to the mobile telephone MS1 in the possession of the passenger.

The passenger wishes to access information about hotels located in the area of their intended stop. Once an indication of a desire for hotel information has been made, the internet based service provider requires, as illustrated in FIG. 9, only the location upon which the hotel information is to be based. The processor of the apparatus employed by the internet based service provide then retrieves from a database 72 the appropriate hotel information and arranges to submit that information for delivery back to the mobile telephone of the passenger.

In the arrangement described above and accordance with the present invention, the TOA information and the stop on route is provided as follows:

The schedule information 50 and information identifying the last stop that the train either went through or departed 51 is broadcast from the beacon to the mobile cellular telephone MS1 and the passenger's intended stop on route is provided to the mobile cellular telephone by the passenger in the manner described below. The TOA of the mobile telephone at the passenger's intended stop on route is then estimated, both in relative terms minutes and absolute in relation to a time clock maintained by the microprocessor 22 of the cellular telephone. For example, where the passengers intended stop on route is station S6 and the beacon is indicating that the train has gone through or departed station S1, the relative TOA at station S6 (rTOA₁₋₆) can be approximated as follows:

rTOA₁₋₆=t₁+t₂+t₃+t₄+t₅ [Equation 1.1]

or rTOA₁₋₆=t₂+t₃+t₄+t₅ [Equation 1.2]

or rTOA₁₋₆=t₁/2+t₂+t₃+t₄+t₅ [Equation 1.3]

As the train may either at station S1 or between station S1 and station S2, without further positional information, the validity of the component t₁ can not be established. As such, the TOA estimate can either include it (equation 1.1), discarded it (equation 1.2) or, reflecting a position between station S1 and station S2, include a proportion of it (equation 1.3). In equation 1.3, the proportion of T1 contributing to the TOA is one halve, though if a timer is employed to monitor the elapsed time from receipt of an indication from the travel information beacon that a station has been left of passed through, a more accurate interpolation can be applied. TOA estimates may be provided for either all or some stations on the route, or just for the passenger's intended stop.

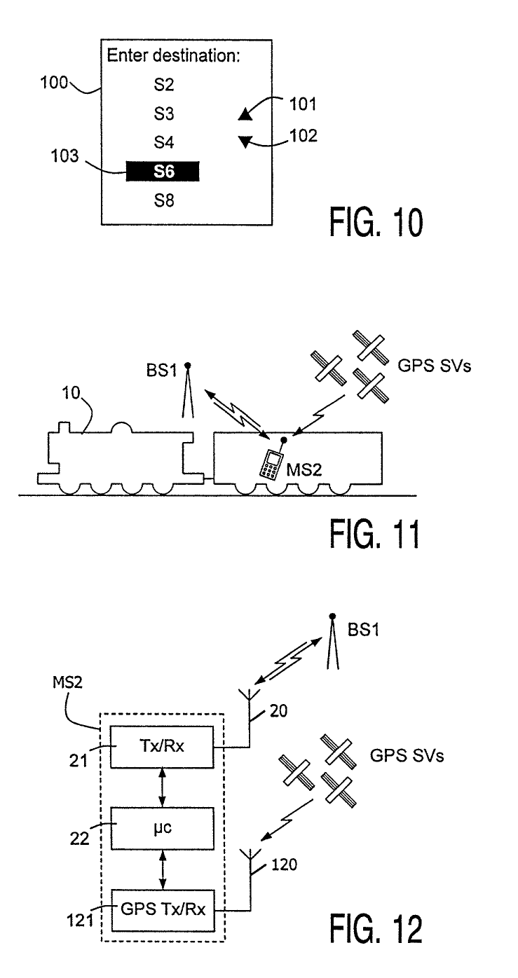

Whilst the passenger could manually enter their intended stop, it is preferable to minimize the onus on data entry by the passenger by providing a mobile cellular telephone that deduces which of the stations are possible destinations for the passenger and presents a list of the possible destinations to the passenger for him/her to choose the correct one. In the above example, the passenger can not get off at stations S1, S5 or S7 and therefore the passenger may be presented with a list of stations consisting of S2, S3, S4, S6, and S8. Such a display 100 is illustrated in FIG. 10 where one of the list is highlighted 103 to indicate the currently selected option, and two graphics are displayed 101, 102 to indicated that the user can scroll up and down to change the selected option using an appropriate user interface (not shown). Where there exists only one possible destination, for example S8 where the train has departed S6, that station can be automatically used to provide a TOA estimate without prompting or confirmation from the passenger.

FIGS. 11 and 12 shows an alternative mobile cellular telephone MS2 in accordance with the present invention and employed in an arrangement similar to that of shown in FIG. 1. In addition to the conventional components of mobile telephone MS1, telephone MS2 further comprises a GPS receiver (GPS Rx) 121 connected to a GPS antenna 120 and controlled by a microprocessor 22. When operative, the GPS signals may be acquired and tracked for the purpose of deriving pseudorange information from which the location of the mobile telephone can be determined using conventional navigation algorithms. Such methods for GPS signal acquisition, tracking and position determination are well known, for example, GPS Principles and Applications (Editor, Kaplan) ISBN 0-89006-793-7 Artech House.

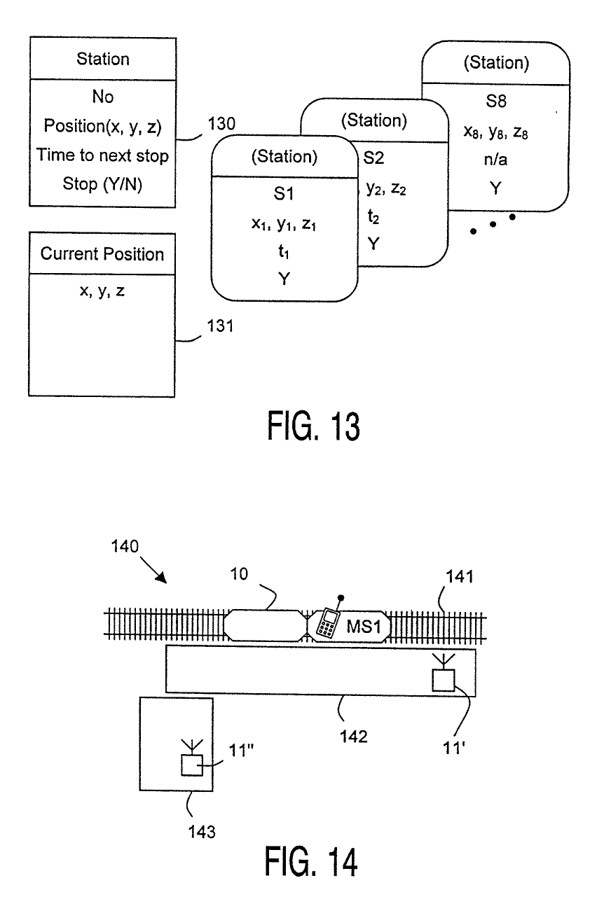

The schedule information 130 is provided to the mobile cellular telephone by an internet service over the cellular telephone network and is illustrated in FIG. 13 comprises Cartesian co-ordinates (xₙ, yₙ, zₙ) describing the position of each station n on route, the expected time taken for the train to travel from station n to the next station along the line tₙ and an indication of whether or not the train with stop at that particular station. As an alternative to using the information identifying the last stop that the train either went through or departed 131, mobile cellular telephone MS2 is able to determine its own position (x, y, z) and compare its position to the position co-ordinates of the stations on route to determine the stop on route that it is nearest to and therefore estimate a TOA at the passengers intended destination.

FIG. 14 illustrates an alternative deployment of travel information beacons in a train station 120 in which a train 10 is located on a track 121 adjacent a platform 122 and a ticket office 123. Travel information beacons may be located on the platform, for example, broadcasting platform specific information, of at a ticket office or in or near to the ticket office. Using any one of these beacons, mobile cellular telephones MS1 and MS2 may be provided with schedule information prior to the passenger getting on the train.

The use of remote internet access, travel information beacons, mobile telephones with positioning capability and other features described above enables the estimation of a TOA to be done in many different ways including the following examples:

### EXAMPLE 1

A travel information beacon located on a train that is aware of its current position (by any conventional means) and is in position of up to date schedule information for the train it is current location on. This information is sent using a Bluetooth wireless link to a mobile telephone in the possession of a passenger on the train and which contains an electronic ticket valid for a particular stop ahead on the route. Such ticketing is known and currently employed in, at least to the applicants knowledge, train stations in Switzerland and Austria. For the stop designated by the electronic ticket, the TOA of the train at that stop is determined by the mobile telephone and the designated stop and TOA are automatically inserted into an SMS message further containing a request to be met at the train station by the passenger's spouse. That message may then be transmitted to the user.

### EXAMPLE 2

As example 1 except that the travel information beacon determines TOAs for all stops ahead and sends the TOAs and identities of the stops to the mobile telephone. The appropriate stop and TOA, designated by the electronic ticket, is then inserted into the SMS message.

### EXAMPLE 3

As example 2 except that the mobile telephone interrogates the travel information beacon for the TOA at the stop designated by the electronic ticket.

### EXAMPLE 4

As example 1 except that the schedule information is provided by the cellular telephone accessing a remote data store via a cellular telephone network. The beacon still provides the position of the train.

### EXAMPLE 5

A travel information beacon located at a train station is in position of up to date schedule information including the Cartesian co-ordinates of stations on routes of trains that pass through that particular station. This information is sent using a wireless link to a PDA in the possession of a passenger arriving at the station to board a train, the PDA having an integral GPS receiver. When on the train, the PDA determines its position and direction in relation to the train route and stops on that route. A TOA is calculated for a stop selected by the user from a list of such stops displayed to the user and the stop and TOA information is inserted in to an input field of an internet web page accessed by the PDA, the purpose of the web page being for pre-ordering taxis from a taxi service provider.

### EXAMPLE 6

As example 5 except that only TOA information is sent, the taxi pick being inherent to taxi service provider or that particular web page, for example, a London taxi firms taxi ordering page for London Waterloo train station.

### EXAMPLE 7

As example 5 except that the PDA interrogates the travel information beacon for schedule information relating to a particular schedule, say as designated by an electronic ticket or selected by a user.

It should of course be appreciated that all the above-mentioned illustrations of the present invention are merely schematic in nature and the present invention is not restricted to the details of these illustrated embodiments. For example, the database 72 can be provided by means of a local storage combination of ROM and RAM storage devices or may in fact be remote from the Internet Service Provider 63 and accessed by means of a separate web application. In this manner the Internet Service Provided 63 can advantageously be associated with a variety of different transport providers so as to increase the selection of travel-related information available and so increase the likelihood of providing the most appropriate response to the user. Also, the exact position of the mobile telephone MS2 need not be calculated at the mobile telephone itself but can rather also be calculated by means of the processor at the Internet service provider or by the mobile phone network. Likewise, once having achieved an appropriate software download from the Internet connection illustrated in FIG. 1 to the mobile telephone 12, the mobile telephone can alternatively be enabled to conduct a local calculation serving to answer the user's travel-related request.

1. A method of providing travel related information to a user of a mobile communications device comprising the steps of:
determining whether the mobile communications device is either travelling on a transport, has recently traveled on a transport, or is likely to travel on a transport at some time in the near future; and
depending on the outcome of that determination, displaying to a user on the mobile communications device selected travel related information.

2. A method according to claim 1 wherein the travel related information includes the identity of at least one location on the route of the transport.

3. A method according to claim 2 wherein the travel related information includes the identities of more than location on the route of the transport and wherein the user is able to select as an option one of the locations displayed.

4. A method according to claim 2 wherein the transport is a scheduled transport; and wherein the travel related information includes the identity of at least one scheduled stop on the route.

5. A method according to claim 4 wherein the mobile communications device is determined to be travelling on the scheduled transport; and wherein the travel related information only includes those stops at which the user may subsequently alight the scheduled transport.

6. A method according to claim 3 wherein the mobile communications device is determined to be travelling on the scheduled transport; and wherein the travel related information further includes estimated time-of-arrival (TOA) information, the method further comprising the steps of:
(iii) providing an estimate of the current position of the mobile communications device;
(iv) providing schedule information relating to the route of that transport; and
(v) calculating an estimate of the TOA of the scheduled transport for at least one subsequent stop on route.

7. A method according to claim 6 wherein the travel related information includes the identities and TOAs for more than one stop on the route of the scheduled transport; and wherein the user is able to select as an option one of the stops displayed.

8. A method according to claims 1 wherein the travel related information is displayed for the purpose of enabling to user of the mobile communications device to access over a wireless link supplementary travel related information from an information service provider.

9. A method according to claim 8 wherein the travel related information displayed is an advertisement to obtain the supplementary travel related information.

10. A method according to claim 8 wherein the travel related information comprises a link to a website or mailbox of the information service provider.

11. A method according to any of claims 8 to 10 wherein the supplementary information is specifically related to a location on the route of the transport.

12. A method according to claim 1 wherein the travel related information is displayed for the purpose of enabling to user of the mobile communications device to procure over a wireless link a travel related service for or on behalf of the user from a service provider.

13. A method according to claim 12 wherein the travel related information displayed is an advertisement for the travel related service.

14. A method according to claim 12 wherein the travel related information comprises a link to a website or mailbox of the service provider.

15. A method according to any of claims 12 wherein the travel related service is specifically related to a location on the route of the transport.

16. A method according to claim 1 wherein the travel related information comprises advertising.

17. A method according to claim 1 wherein the travel related information comprises information obtained from a website.

18. A method according to claim 17 wherein upon the website is automatically connected to upon the determination of whether the mobile communications device is either travelling on a transport, has recently traveled on a transport, or is likely to travel on a transport at some time in the near future.

19. A method according to claim 1 in which at least part of the determination of whether the mobile communications device is either travelling on a transport, has recently traveled on a transport, or is likely to travel on a transport at some time in the near future is done by identifying whether the mobile communications device is currently or has recently received a message broadcasted from a transmitter located either on the scheduled transport, on or near the scheduled transport route or at or near a stop on the scheduled transport route.

20. A method according to claim 1 in which at least part of the determination of whether the mobile communications device is either travelling on a transport, has recently traveled on a transport, or is likely to travel on a transport at some time in the near future is done by identifying whether the mobile communications device is located on the route of a scheduled transport or at or near a scheduled transport terminus.

21. A method according to claim 20 wherein the mobile communications is currently or has recently received a message broadcasted from a transmitter located either on the scheduled transport, on or near the scheduled transport route or at or near a stop on the scheduled transport route, the message containing an estimate of the position of the transmitter; and wherein that position is used as an estimate of the position of the mobile communications device.

22. A method according to claim 20 wherein the mobile communications device comprises position determining means.

23. A method according to claim 22 wherein the position determining means is a GPS receiver.

24. A method according to claim 22 wherein the position determining means is a communications receiver and communications processor adapted to determine the position of the mobile communications devices in cooperation with a plurality of cellular communication base stations.

25. A method according to claim 1 in which at least part of the determination of whether the mobile communications device is either travelling on a transport, has recently traveled on a transport, or is likely to travel on a transport at some time in the near future is done by identifying whether the mobile communications device has been instructed by the user that either the user is travelling on a scheduled transport, has recently traveled on a scheduled transport or intends to travel on a scheduled transport at some time in the near future.

26. A method according to claim 1 in which at least part of the determination of whether the mobile communications device is either travelling on a transport, has recently traveled on a transport, or is likely to travel on a transport at some time in the near future is done by identifying whether the mobile communications device is currently in possession of an electronic ticket permitting travel on a scheduled transport.

27. A method according to claim 26 wherein the travel related information is specifically related to a route identified by the e-ticket.

28. A method according to claim 27 wherein the travel related information is specifically related to stop on the route identified by the e-ticket.

29. A mobile communications device adapted to receive and display to a user travel related information provided by a method according to claim 1.

30. A mobile communications device comprising a processor for determining whether the mobile communications device is either travelling on a transport, has recently traveled on a transport, or is likely to travel on a transport at some time in the near future.

31. A mobile communications device according to claim 30 further comprising a display, wherein the mobile communications device is configured to display travel related information to a user of the mobile communications device depending on the outcome of the determination of whether the mobile communications device is either travelling on a transport, has recently traveled on a transport, or is likely to travel on a transport at some time in the near future.

32. A mobile communications device according to claim 31 wherein the travel information includes the identity of at least one location on the route of the transport.

33. A mobile communications device according to claim 32 wherein the travel related information includes the identities of more than location on the route of the transport and wherein the user is able to select as an option one of the locations displayed.

34. A mobile communications device according to claim 32 or claim 33 wherein the transport is a scheduled transport; and wherein the travel related information includes the identity of at least one scheduled stop on the route.

35. A mobile communications device according to claim 34 wherein, in the event that the mobile communications device determines that it is travelling on the scheduled transport, the travel related information displayed includes only those stops at which the user may subsequently alight the scheduled transport.

36. A mobile communications device according to claim 34 wherein the travel related information further includes estimated TOA information for at least one subsequent stop on route determined by the processor from an estimate of the current position of the mobile communications device and schedule information relating to the route of that transport.

37. A mobile communications device according to claim 36 wherein the travel related information includes the identities and TOAs for more than one stop on the route of the scheduled transport; and wherein the user is able to select as an option one of the stops displayed.

38. A mobile communications device according to claim 30 further comprising a wireless link suitable for connecting to a remote information service provider; and wherein the travel related information is displayed for the purpose of enabling to user of the mobile communications device to access over that wireless link supplementary travel related information from that information service provider.

39. A mobile communications device according to claim 38 wherein the travel related information comprises a link to a website or mailbox of the information service provider.

40. A mobile communications device according to claim 30 further comprising a wireless link suitable for connecting to a remote travel related service provider; wherein the travel related information is displayed for the purpose of enabling to user of the mobile communications device to procure over the wireless link a travel related service for or on behalf of the user from that service provider.

41. A mobile communications device according to claim 40 wherein the travel related information comprises a link to a website or mailbox of the service provider.

42. A mobile communications device according to claim 30 wherein the processor is configured to determine whether the mobile communications device is either travelling on a transport, has recently traveled on a transport, or is likely to travel on a transport at some time in the near future by identifying whether the mobile communications device is currently or has recently received a message broadcasted from a transmitter located either on the scheduled transport, on or near the scheduled transport route or at or near a stop on the scheduled transport route.

43. A mobile communications device according to claim 30 wherein the processor is configured to determine whether the mobile communications device is either travelling on a transport, has recently traveled on a transport, or is likely to travel on a transport at some time in the near future by identifying whether the mobile communications device is located on the route of a scheduled transport or at or near a scheduled transport terminus.

44. A mobile communications device according to claim 43 wherein in the event that the mobile communications is currently or has recently received a message broadcasted from a transmitter located either on the scheduled transport, on or near the scheduled transport route or at or near a stop on the scheduled transport route, and that message contains an estimate of the position of the transmitter, the processor of the mobile communications device is configured to subsequently use that position as an estimate of its own position.

45. A mobile communications device according to claim 43 further comprising position determining means.

46. A mobile communications device according to claim 45 wherein the position determining means is a GPS receiver.

47. A mobile communications device according to claim 45 wherein the position determining means is a communications receiver and communications processor adapted to determine the position of the mobile communications devices in co-operation with a plurality of cellular communication base stations.

48. A mobile communications device according to claim 30 wherein the processor is configured to determine whether the mobile communications device is either travelling on a transport, has recently traveled on a transport, or is likely to travel on a transport at some time in the near future by identifying whether the mobile communications device has been so instructed by a user.

49. A mobile communications device according to claim 30 wherein the processor is configured to store an electronic ticket permitting travel on a scheduled transport and to determine whether the mobile communications device is either travelling on a transport, has recently traveled on a transport, or is likely to travel on a transport at some time in the near future is done by identifying whether the mobile communications device is currently in possession of such a ticket.

50. A mobile communications device according to claim 49 wherein the travel related information is specifically related to a route identified by the e-ticket.

51. A mobile communications device according to claim 50 wherein the travel related information is specifically related to a stop on the route identified by the e-ticket.

52. A travel information beacon adapted to broadcast travel related information including schedule information relating to the route of a scheduled transport.

53. A travel information beacon according to claim 52 wherein the travel related information includes estimated TOA information relating to at least one stop on the route of the scheduled transport.

54. A travel information beacon according to claim 53 further comprising position determining means for determining an estimate of its position, wherein the estimated TOA information is calculated from an estimate of the current position of the travel information beacon and schedule information relating to the scheduled transport.

55. A travel information beacon according to claim 52 located either on a scheduled transport, on or near the scheduled transport route or at or near a stop on the scheduled transport route.

56. A travel information beacon adapted to broadcast travel related information and an estimate of the position of the beacon.

57. A travel information beacon according to claim 56 further comprising position determining means for providing the estimate of the position of the beacon.

58. A travel information beacon according to claim 57 wherein the position determining means is a GPS receiver.

59. A travel information beacon according to claim 56 wherein the travel related information includes schedule information relating to the route of a scheduled transport.

60. A travel information beacon according to claim 56 and located either on a scheduled transport, on or near the scheduled transport route or at or near a stop on the scheduled transport route.

61. A travel information beacon for broadcasting travel related information and located either on or near the scheduled transport route or at or near a stop on the scheduled transport route.

62. A travel information beacon according to claim 61 attached to a shelter for a stop on the scheduled transport route.
